(19) United States
(12) Patent Application Publication
(10) Pub. No.: US 2005/0082307 A1
(43) Pub. Date: Apr. 21, 2005

(54) Cutlery dispenser system

(76) Inventor: Terence Tucker, San Clemente, CA (US)

Correspondence Address: Kit M. Stetina, Esq.;STETINA BRUNDA GARRED & BRUCKER, Suite 250, 75 Enterprise, Aliso Viejo, CA, 92656, US

(21) Appl. No.: 10/690,288

(22) Filed: Oct. 21, 2003

(51) Int. Cl. G07F 11/08; B65D 1/34

(52) U.S. Cl. 221/67; 206/553; 211/70.7

(57) ABSTRACT

Provided is a cutlery dispenser system for dispensing cutlery utensils wherein each one of the utensils has an elongate handle extending from an eating portion. The cutlery dispenser system comprises a support rack, at least one bin and at least one cartridge. The bin is configured to be removably mountable to the support rack and has an open bin front. The bin may have a bin top that is covered by a bin cover. The cartridge is configured to be removably insertable into the bin through the bin front. The cartridge has at least one vertical slot which opens to the cartridge top and the cartridge side. The vertical slot is configured to contain a stack of the utensils wherein the handles protrude laterally beyond the cartridge side such that at least one of the utensils may be removed by upward movement beyond the cartridge top.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates in general to hand-operable dispenser systems for dispensing goods and, more particularly, to a uniquely configured cutlery dispenser system specifically adapted for dispensing eating utensils one-at-a-time.

The fast-food, self-serve restaurant industry has become a major, if not primary, destination of individuals and families who are now eating out more often for breakfast, lunch and dinner. While such restaurants provide a generally pleasant atmosphere in which to enjoy adequately nutritious fare, these restaurants generally do not provide the more refined amenities that may be found in typical sit-down restaurants with wait service.

One area of concern in such fast-food, self-serve restaurants concerns sanitation or cleanliness in dispensing cutlery utensils and, more specifically, the manner in which cutlery utensils are provided for self-selection by customers. Self-serve restaurants provide customers with only a few approaches regarding self-selection of cutlery utensils: (1) providing individually wrapped utensils, or (2) providing a container or bin filled with unwrapped utensils into which customers place their hands to retrieve a fork, knife, or spoon. As is apparent, the former approach assures cleanliness but is relatively costly. The latter approach is more economical but may allow the spread of hand-carried bacteria to the unwrapped utensils in the bin for potential transmission to future customers.

Included in the prior art are a few devices directed towards dispensing utensils in a sanitary manner. U.S. Pat. No. 2,421,782 issued to Gibbs et al. (the '282 reference) discloses an open front and top storage and dispensing device for dispensing spoons. The dispensing device includes extensions that generally define the outline of a handle portion. The extension is formed such that an operative part of the spoon may not pass through the extension. The dispensing device includes a latch that permits upward withdrawal of the spoon from the dispensing device while preventing replacement of the spoon back into the extension. As understood, the dispensing device of the '282 reference appears to prevent contamination of spoons. However, the '282 reference unfortunately includes the latch which adds complexity and cost to the dispensing device.

In light of the above-described drawbacks of prior art utensil dispensers and in view of the important sanitation concerns of bin-held utensils as balanced by economic concerns in providing individually wrapped utensils, it is apparent that there exists a need for a cutlery dispenser system that can maintain and supply clean cutlery utensils without the costs associated with individually wrapped knives, forks, and spoons. In addition, there exists a need in the art for a cutlery dispenser system capable of dispensing utensils such that remaining utensils in the dispenser system do not become contaminated.

Additionally, there exists a need in the art for a cutlery dispenser system wherein a cartridge may be filled with utensils such that the utensils in the cartridge may be retrieved by a user in one-at-a-time fashion. Furthermore, there exists a need in the art for a cutlery dispenser system configured for accommodating identically constructed cartridges with each cartridge being capable of housing knives, forks and spoons or any combination thereof.

### BRIEF SUMMARY OF THE INVENTION

Provided is a cutlery dispenser system configured to dispense cutlery utensils such as disposable utensils as are commonly utilized in fast food restaurants. Each one of the utensils may have an eating portion with a handle extending therefrom. The utensils may be arranged in a stack in the cartridge such that a user may selectively withdraw a utensil. The cartridge is configured such that the handle of each one of the utensils extends laterally out of the cartridge such that the user may withdraw the utensil by grasping the handle and lifting the utensil upwardly out of the cartridge. The eating portion of each one of the utensils is disposed within the cartridge to prevent contamination thereof.

The stacks of utensils contained within the cartridge may be a combination of stacks of knifes and/or stacks of forks and/or stacks of spoons although various other combinations of stacks of utensils may be accommodated within the cartridge. The cutlery dispenser system may be comprised of at least one bin and at least one cartridge although multiple bins and cartridges may be included. The bin has an open bin front such that the cartridge may be removably insertable into the bin. A bin cover 86 may be disposed or attached to a bin top 30 of the bin 26. The cartridge has at least one vertical slot opening to a cartridge top and a cartridge side with the vertical slot being configured to contain the stack of the utensils. The vertical slot is configured such that at least one of the utensils may be removed by upward movement thereof beyond the cartridge top.

The vertical slots may be shaped complementary to an outline of one of the utensils. The cartridge may include at least one but preferably three of the vertical slots disposed in side-be-side arrangement. The vertical slots may be aligned with one another or the vertical slots may be arranged in a staggered formation and may be substantially identically shaped and sized. In this regard, the vertical slots may be sized to accommodate knives, forks and spoons in any one of the three compartments. The vertical slots may include a step that is sized and configured to be complementary to a profile of one of the utensils such that handles of the utensils may be substantially horizontally oriented when utensils are stacked in the vertical slots. The cartridge may have a lid member that is removably engagable to the cartridge top such that the eating surface of each one of the pieces of cutlery is covered in order to provide some measure of protection against contamination.

The bin may have a plurality of bays disposed in side-by-side arrangement with adjacent ones of the bays being separated by a divider panel. The bin may be configured to have any number of bays with each one of the bays being configured to contain any number of the cartridges. The bin may have a bottom panel, a rear wall and opposing side walls interconnected by the bottom panel and the rear wall. The bin cover may be bonded to the bin or the bin cover may be integrally formed with the bin. The bottom panel may have a vertical lip extending upwardly therefrom to restrict movement of the cartridge. The cartridge may be configured to be accommodated within standard-sized condiment containers that are commonly used in the food service industry. Such condiment containers are typically used to dispense various items such as napkins or packets of ketchup, mayonnaise, relish and the like.

The cutlery dispenser system may further include a support rack configured to removably mount the bin thereto by means of an elongate groove formed in an upper portion of the support rack. The bin may have a hook flange configured to be removably engagable to the groove for securing the bin to the support rack. The support rack may be sized and configured to support a plurality of bins in side-by-side arrangement or to support a single one of the bins. The support rack may be comprised of a pair of opposing side members interconnected by a first transverse member optionally, a second transverse member may be disposed in generally parallel spaced arrangement to the first transverse member in a tiered configuration such that bins may be mounted on the support rack in a tiered arrangement.

The cartridge, the lid member, the bin, the bin cover and the support rack may be fabricated of any material but, preferably, polymeric material such as polyethylene may be used due to its favorable durability characteristics and its capability to withstand high temperatures typical of dishwashing machines. The cutlery dispenser system may be mounted to a rotatable base wherein the support rack is configured in a square shape to provide two identically constructed opposing sides upon which bins may be mounted. In this regard, the support rack may be rotated on the rotatable base in order to improve access to utensils contained within the cartridges.

In operation, utensils may be initially inserted into the vertical slots in the stack arrangement. Once loaded with utensils, the lid member may be engaged to the cartridge top during transit. In preparing the cutlery dispenser system for dispensing the utensils, the layer of elastomeric material may be removed and the cartridge may be inserted into one of the bins. The lid member may be removed exposing an uppermost one of the utensils in each one of the stacks. The bins may be mounted on the support rack by engaging the hook flange to the groove. If the support rack is provided in a tiered configuration, lower ones of the bins may be filled with condiment packets, napkins and the like although both upper and lower ones of the bins may be utilized to contain cartridges of utensils. The user withdraws one of the utensils by grasping the handle and lifting the utensil upwardly beyond the cartridge top to remove the utensil from the vertical slot.

### BRIEF DESCRIPTION OF THE DRAWINGS

These as well as other features of the invention will become more apparent upon reference to the drawings wherein:

FIG. 1 is a plan view of the cutlery dispenser system in an aspect of the invention illustrating a cartridge containing a plurality of cutlery utensils having handles extending laterally out of the cartridge;

FIG. 2 is an exploded cross-sectional side view of the cartridge taken along line 2-2 of FIG. 1 showing a lid member disposed above the cartridge;

FIG. 3 is a cross-sectional front view of the cartridge taken along line 3-3 of FIG. 1 illustrating a plurality of vertical slots formed within the cartridge and in which the utensils may be stacked;

FIG. 4 is a partial cross-sectional view of the cartridge taken along line 4-4 of FIG. 1 showing the lid member secured to a cartridge top;

FIG. 5 is a bottom view of the cartridge illustrating the vertical slots as may be included with the cartridge;

FIG. 6 is a perspective view of the cartridge having the utensils stacked therewithin and further illustrating the cartridge encapsulated in a layer of elastomeric material;

FIG. 7 is a plan view of the cutlery dispenser system in another aspect of the invention illustrating a cartridge containing a plurality of a single type of utensil;

FIG. 8 is an exploded cross-sectional side view of the cartridge taken along line 8-8 of FIG. 7 showing spoons contained within the cartridge;

FIG. 9 is a bottom view of the cartridge taken along line 9-9 of FIG. 7 illustrating the vertical slots;

FIG. 10 is an exploded perspective view of the dispenser system in another aspect of the invention illustrating bins that are engagable to a support rack and further illustrating a cartridge disposed above one of the bins;

FIG. 11 is a plan view of one of the bins taken along line 11-11 of FIG. 10;

FIG. 12 is a cross-sectional side view of the bin taken along line 12-12 of FIG. 11 illustrating a bin cover disposed on a bin top;

FIG. 13 is a cross-sectional front view of the bin taken along line 13-13 of FIG. 11;

FIG. 14 is a plan view of the dispenser system in another aspect of the invention illustrating a pair of the cartridges disposed on opposing sides of the support rack;

FIG. 15 is a cross-sectional view of the support rack taken along line 15-15 of FIG. 14 illustrating the support rack mounted on a rotatable base; and

FIG. 16 is a bottom view of the support rack taken along line 16-16 of FIG. 15.

### DETAILED DESCRIPTION OF THE INVENTION

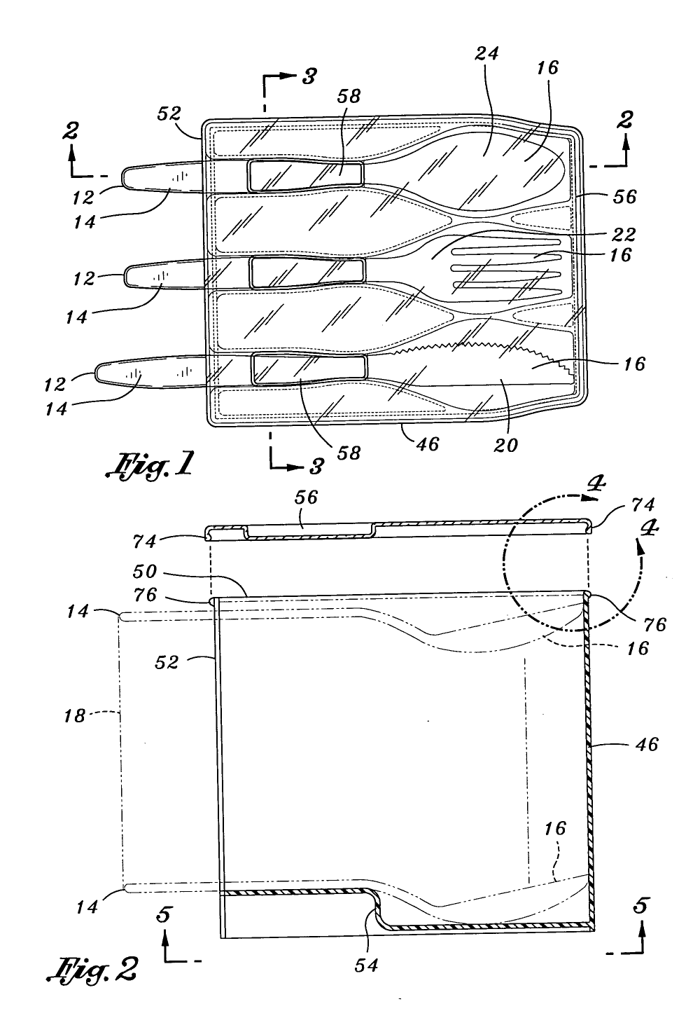

The invention will now be described with reference to the accompanying drawings. FIGS. 1-6 illustrate a cartridge 46 of the cutlery dispenser system 10 wherein the cartridge 46 contains a plurality of cutlery utensils 12. The utensils 12 may be disposable plastic or polypropylene utensils 12 such as are commonly utilized in fast food restaurants. However, it is contemplated that the utensils 12 may be silverware as is commonly utilized in wait service restaurants. In this regard, the utensils 12 may be fabricated from any suitable material. Each one of the utensils 12 may have an eating portion 16 with a handle 14 extending therefrom. The utensils 12 may be arranged in a stack 18 in the cartridge 46 such that a user may selectively withdraw at least one utensil 12. The cartridge 46 is configured such that the handle 14 of each one of the utensils 12 extends laterally out of the cartridge 46. In this manner, the user may withdraw the utensil 12 by grasping the handle 14 and lifting the utensil 12 upwardly out of the cartridge 46.

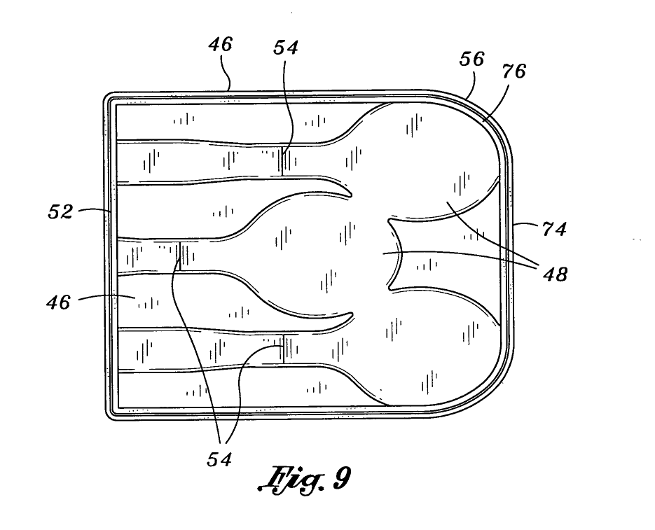

As can be seen in FIG. 1, the eating portion 16 of each one of the utensils 12 is disposed within the cartridge 46 to prevent contamination thereof. For example, in the case where the utensil 12 is a spoon 24 having a bowl portion as the eating portion 16, the cartridge 46 is configured such that the bowl portion is contained within the cartridge 46 in order to reduce the risk of contamination due to human contact, as can be seen in FIGS. 7-9. Similarly, for the case where the utensil 12 is a fork 22 having a plurality of tines as the eating portion 16, the cartridge 46 is configured such that the tines of the fork 22 are contained within the cartridge 46. Likewise, for the case where the utensil 12 is a knife 20 having a blade portion as the eating portion 16, the cartridge 46 is configured such that the blade portion is contained within the cartridge 46 in order to reduce the risk of contamination.

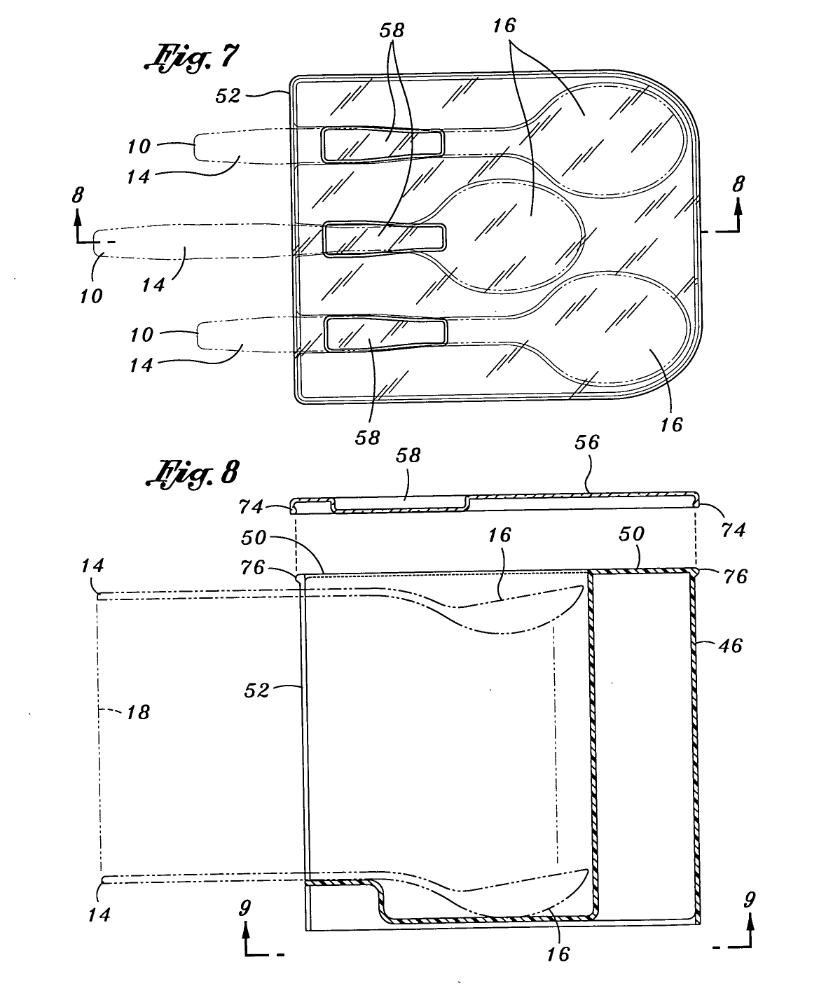

Referring briefly to FIG. 6, shown is the cartridge 46 and utensil 12 stacks 18 hermetically sealed or encapsulated by a film or layer of elastomeric material 78 such as clear polyvinylchloride (PVC) film which is more commonly referred to as shrink-wrap. However, it should be noted that many other elastomeric materials may be used to encapsulate the cartridge 46 and utensil 12 stacks 18. Preferably, the clear PVC layer may be used as it conforms to difficult shapes while meeting Food and Drug Administration (FDA) requirements for indirect food contact. The layer of elastomeric material 78 encapsulating the cartridge 46 and stacks 18 of the utensils 12 protects the utensils 12 during shipping, handling and storage against contamination from human contact or from airborne bacteria, dirt, germs, etc.

The stacks 18 of utensils 12 contained within the cartridge 46 may be a combination of stacks 18 of knives 20 and/or stacks 18 of forks 22 and/or stacks 18 of spoons 24 although various other combinations of stacks 18 of utensils 12 may be accommodated within the cartridge 46. Furthermore, the cartridge 46 may be configured such that stacks 18 of utensils 12 may be comprised of a single type of utensil 12. For example, the cartridge 46 may be configured to contain stacks 18 of spoons 24 in a staggered arrangement, as is shown in FIGS. 7-9.

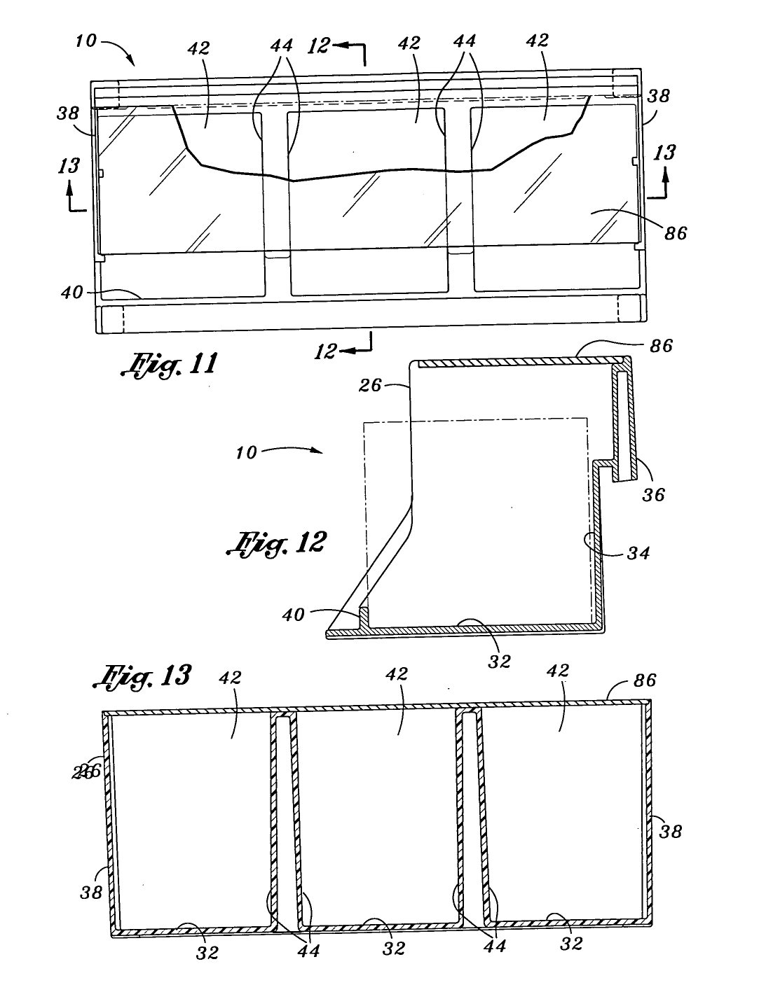

Referring to FIGS. 10-13, the cutlery dispenser system 10 may be comprised of at least one bin 26 and at least one of the cartridges 46 although multiple ones of the bins 26 and multiple ones of the cartridges 46 may be included with the cutlery dispenser system 10. Furthermore, the cutlery dispenser system 10 may include a support rack 62 configured to removably mount the bin 26 in a manner that will be described in greater detail below. As can be seen in FIG. 10, the bin 26 has an open bin front 28 through which the cartridge 46 may be inserted and placed into the bin 26. The cutlery dispenser system 10 may include a bin cover 86 that may be disposed on a bin top 30.

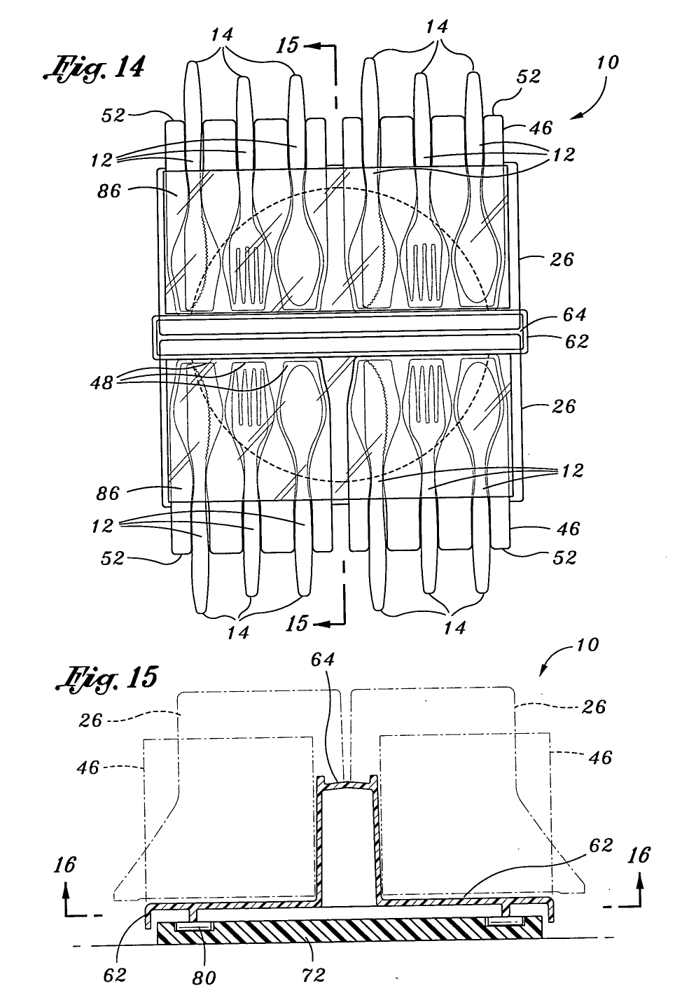

The bin cover 86 may be bonded to upper edges of a bin 26 perimeter, as can be seen in FIG. 12 and 13. Alternatively, the bin cover 86 may be fastened to the bin top 30 by any suitable means. For example, the bin cover 86 may be mechanically fastened to the bin top 30. The cartridge 46 is removably insertable into the bin 26 through the bin front 28. The cartridge 46 has at least one vertical slot 48 opening to a cartridge top 50 and a cartridge side 52 with the vertical slot 48 being configured to contain the stack 18 of the utensils 12. As was earlier mentioned and as is shown in FIG. 10, the handles 14 of the utensils 12 protrude laterally beyond the cartridge side 52. In addition, the vertical slot 48 is configured such that at least one of the utensils 12 may be removed by upward movement thereof beyond the cartridge top 50.

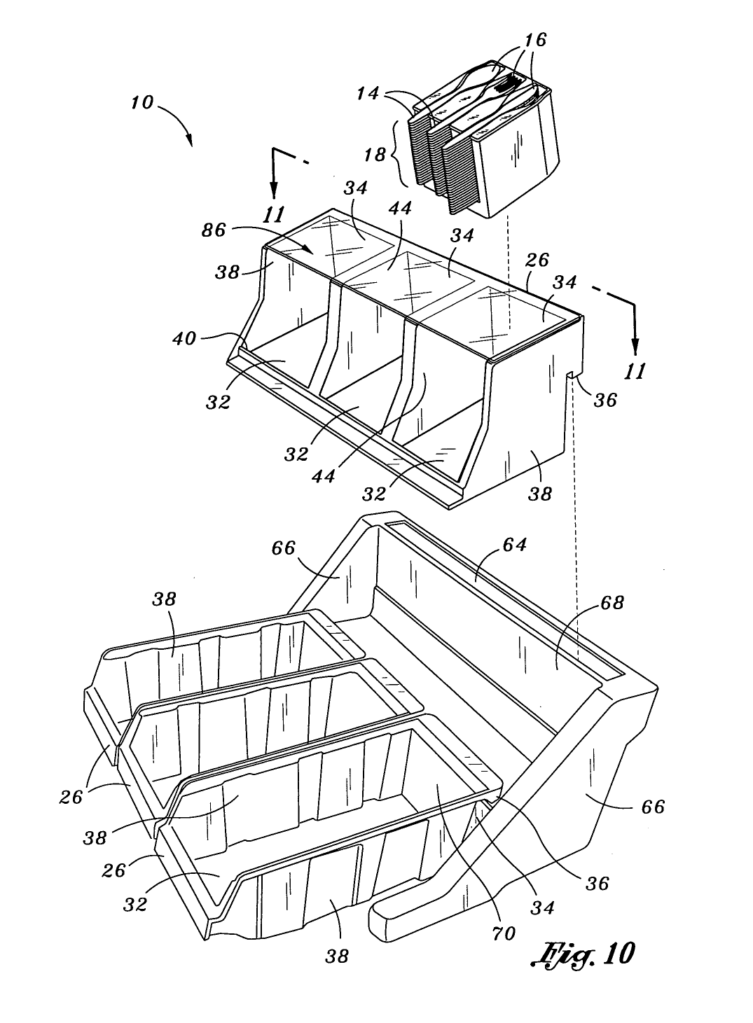

The vertical slot 48 may be shaped complementary to an outline of one of the utensils 12 although alternative shapes of the vertical slots 48 may be utilized. The cartridge 46 may include at least one but preferably three of the vertical slots 48 disposed in side-be-side arrangement, as shown in FIGS. 1-10. However, any number of vertical slots 48 may be incorporated into the cartridge 46. If multiple ones of the vertical slots 48 are formed within the cartridge, the slots may be aligned with one another, as is shown in FIGS. 1, 5 and 6. Alternatively, in order to reduce an overall width of the cartridge 46, the vertical slots 48 may be arranged in a staggered formation, as shown in FIGS. 7 and 9.

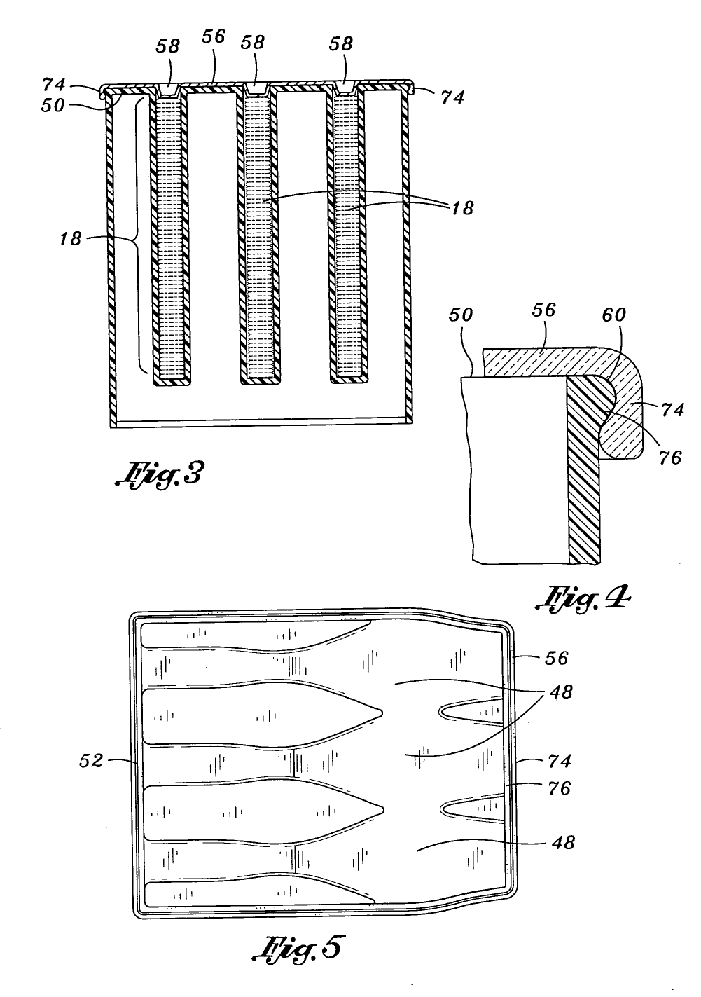

The vertical slots 48 may be substantially identically shaped and sized although the vertical slots 48 may be uniquely shaped complementary to an outline of a particular type of utensil 12 to be stacked within the vertical slot 48. In this regard, the vertical slots 48 may be sized to accommodate knives 20, forks 22 and spoons 24 in any one of the vertical slots 48. In a retail setting, one of the stacks 18 may contain knives 20, another forks 22, and another may contain spoons 24. In an institutional setting, each stack 18 may contain the same type of utensil 12 (e.g., all forks 22 or all spoons 24). The vertical slots 48 may include a step 54 in a lower portion thereof, as is shown in FIG. 2. The step 54 of the vertical slot 48 may be sized and configured to be complementary to a profile of one of the utensils 12 so that handles 14 of the utensils 12 may be substantially horizontally oriented as the handles 14 extend laterally outwardly from the cartridge 46.

Referring briefly now to 1-6, shown is the cartridge 46 having a lid member 56 disposable thereon and configured to be removably engagable to the cartridge top 50. As can be seen in FIG. 2, the lid member 56 is sized and configured to be complementary to the cartridge 46 such that the lid member 56 substantially closes out the cartridge top 50. The lid member 56 is configured such that the eating portion 16 of an uppermost one of each one of the utensils 12 in each of the stacks 18 is covered. In this manner, the lid member 56 covers the vertical slots 48 at the cartridge top 50 to secure the stacks 18 of utensils 12 during transit of the cartridge.

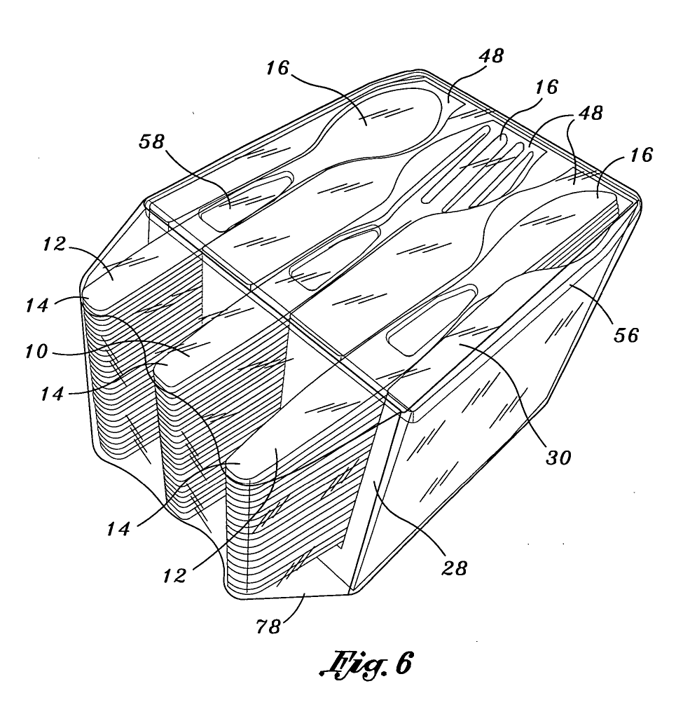

In addition, the lid member 56 provides some measure of protection of the eating portions 16 of the utensils 12 against contamination from human contact or contamination from airborne particles. The lid member 56 may include depressions 58, as can be seen in FIGS. 2, 3, 7 and 8. The depressions 58 may be sized and configured to be complementary to a portion of the vertical slots 48 through which the handles 14 extend. By including the depressions 58 in the lid member 56, the stacks 18 of utensils 12 may be more securely held within the cartridge 46 during transit. Referring to FIG. 4, shown is a partial cross-sectional view of the cartridge 46 showing the lid member. 56 secured to a cartridge top 50 of the cartridge 46. A perimeter of the lid member 56 is configured complementary to a perimeter of the cartridge top 50 such that the lid member 56 may be removably engaged to the cartridge top 50. As shown in FIG. 4, the lid member 56 perimeter may include a downwardly extending vertical lid flange 74 having a recess 60 extending along the lid flange 74.

The cartridge top 50 perimeter may include an outwardly extending rib 76. The vertical flange is sized and configured to engage the recess 60 such that the lid member 56 may securely engage the rib 76. The lid member 56 may be fabricated of resilient material to allow the vertical flange to extend over the rib such that the lid member 56 may be releaseably attached to the cartridge 46. As shown in FIG. 6, the lid member 56 may be encapsulated within the shrink-wrap which may later be removed prior to placing the cartridge 46 in the bin 26.

Referring now to FIGS. 10-13, shown is the bin 26 in an aspect of the invention wherein the bin 26 has a plurality of bays 42 disposed in side-by-side arrangement. Adjacent ones of the bays 42 may be separated by a divider panel 44. As was earlier mentioned, the bin cover 86 may be disposed on the bin top 30 to provide some measure of protection against contamination of the utensils 12 in the cartridge 46. The bin cover 86 is preferably configured to extend across a width of the bin 26 while accommodating insertion of the cartridge 46 through the bin front 28. In addition, the bin cover 86 is preferably configured to be at least partially transparent to allow the user to see the utensils 12 such that the user may select the desired type of utensil 12 from the cartridge 46.

It should be noted that the bin 26 may be configured to have a single one of the bays 42 for accommodating a single one of the cartridges 46 therein. However, the bin 26 may be configured to have any number of bays 42. Furthermore, each one of the bays 42 may be configured to contain any number of the cartridges 46. Thus, the cutlery dispenser system 10 is provided in a modular configuration wherein bins 26 of different configurations may be used with a support rack 62 to support any number of cartridges 46 from which utensils 12 may be self-dispensed.

As can be seen in FIGS. 10-13, the bin 26 may have a bottom panel 32, a rear wall 34 and opposing side walls 38 interconnected by the bottom panel 32 and the rear wall 34. The bin cover 86 may be disposed on the bin top 30 as was earlier described and as is shown in FIGS. 10-14. It is contemplated that the bin cover 86 may be integrally formed with the bin 30. The side walls 38 and the rear wall 34 may have a ribbed design to add strength and stiffness to the bin 26. The bottom panel 32 may have a vertical lip 40 extending upwardly therefrom to restrict movement of the cartridge 46. The vertical lip 40 may be disposed on a side opposite that of the rear wall 34.

The vertical lip 40 may be sized to extend upwardly to a level below that of a lower end of the vertical slot 48 on the cartridge 46. By so positioning and sizing the vertical lip 40, handles 14 of the utensils 12 extending out of the cartridge 46 may not interfere with the vertical lip 40. The cartridge 46 may be configured to be accommodated within standard-sized condiment containers commonly used in the food service industry. Such condiment containers are typically used to dispense various items such as napkins or packets of ketchup, mayonnaise, relish, and the like.

Referring still to FIG. 10, the cutlery dispenser system 10 may further include the support rack 62 configured to removably mount the bin 26 thereto. As may be seen in FIG. 10, the support rack 62 may have an elongate groove 64 formed in an upper portion thereof. The bin 26 may have a hook flange 36 formed on a side opposite that of the bin front 28 with the hook flange 36 being formed complementary to the groove 64 such that the hook flange 36 is configured to be removably engagable to the groove 64 for securing the bin 26 to the support rack 62.

The support rack 62 may be sized and configured to support a plurality of bins 26 in side-by-side arrangement, as is shown in FIG. 10. Alternatively, the support rack 62 may be sized and configured to support a single one of the bins 26. Regarding its configuration, the support rack 62 may include a pair of spaced-apart opposing side members 66 interconnected by a first transverse member 68 with the elongate groove 64 being formed in an upper portion of the first transverse member 68.

Optionally, the support rack 62 may further include a second transverse member 70 disposed in generally parallel spaced arrangement to the first transverse member 68 in a tiered configuration, as shown in FIG. 10. Similar to the configuration of the first transverse member 68, the second transverse member 70 may also be configured to support at least one of the bins 26 although the second transverse member 70 may be configured to support a plurality of bins 26. In this regard, it is contemplated that any number of transverse members may be included with the support rack 62 in a multi-tiered arrangement.

Regarding materials from which the cutlery dispenser system 10 may be fabricated, it is contemplate that the cartridge 46, the lid member 56, the bin 26, the bin cover 86 and the support rack 62 may each be fabricated of any material including, but not limited to, cardboard, plastic, metal, fiberglass or any other appropriately rigid material. Preferably, the cartridge 46, the lid member 56, the bin 26 and the support rack 62 may each be fabricated of polymeric material such as polyethylene due to its favorable durability characteristics and its capability to withstand high temperatures typical of dishwashing machines. The bin cover 86 may be fabricated of substantially transparent material such as plexiglass although many other materials may be suitably used for the bin cover 86.

Optionally, the bins 26, the cartridges 46 and the support rack 62 may be fabricated from stainless steel. The support rack 62 may include rubber feet (not shown) disposed on an underside thereof at spaced locations about a perimeter of the support rack 62. Such rubber feet may prevent slippage of the support rack 62 while protecting counter tops from damage. The support rack 62 may be formed as a unitary structure as may be the cartridge 46 and the bin. For example, each one of the cartridges 46, bins 26 and support rack 62 may be injected molded of polyethylene although any number of alternative materials and fabrication methods may be utilized to fabricate the cartridges 46, bins 26 and support rack 62.

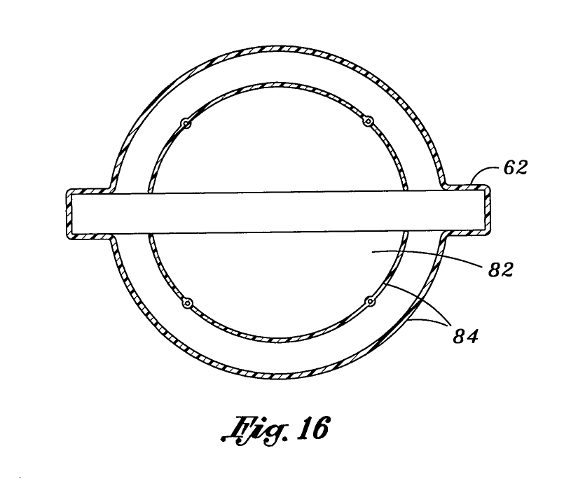

Referring now to FIGS. 14-16, shown is an aspect of the invention wherein the cutlery dispenser system 10 is configured to be mounted to a rotatable base 72. The rotatable base 72 may include a bearing 80 upon which the support rack 62 may be supported. Such a configuration may be utilized to dispense a relatively large amount of one type of utensil 12 or to dispense more than one utensil 12 (i.e., knife 20, fork 22, and spoon 24). More specifically, the aspect of the cutlery dispenser system 10 shown in FIG. 14 includes the support rack 62 configured in a square shape that provides two identically constructed opposing sides upon which bins 26 may be mounted thereto. Although FIG. 14 shows two of the bins 26 being mounted on each one of the opposing sides, it is recognized that any number of bins 26 may be mounted on each one of the opposing sides. Furthermore, the support rack 62 may be configured in any number of shapes and sizes.

Furthermore, it is contemplated that the support rack 62 may be configured such that bins 26 may be mounted to each one of four sides of the support rack 62. The bins 26 may be configured to support any number of the cartridges 46. The support rack 62 may be configured such that the support rack 62 is rotatably supported in a manner wherein multiple boxes and cartridges 46 may be supported by the support rack 62. In this manner, the support rack 62 may be rotated on the rotatable base 72 in order to improve access to utensils 12 contained within the cartridges 46. Two of the cartridges 46 may be supported on each side of the support rack 62 although any number of the bins 26 may be supported on either of the sides of the support rack 62. As can be seen in FIG. 16, the support rack 62 may include a base portion 82 configured in a generally circular shape and having a pair of downwardly extending base ribs 84 to add strength and stiffness to the support rack 62.

The operation of the cutlery dispenser system 10 will now be described with reference to FIG. 10. Utensils 12 may be initially inserted into the vertical slots 48 in the stack 18 arrangement. For settings where it is expected that a heavy volume of a particular type of one of the utensils 12 may be used, each of the vertical slots 48 in the cartridges 46 may be loaded with the stack 18 of the particular type of utensil 12. Once the vertical slots 48 are loaded with the stacks 18 of utensils 12 of the desired type, the lid member 56 may be engaged to the cartridge top 50 to cover the vertical slots 48 and to secure the stacks 18 of utensils 12 during transit. In addition, the lid member 56 provides some measure of protection of the utensils 12 against contamination. The layer of elastomeric material 78 such as clear polyvinylchloride (PVC) film may be applied in order to encapsulate the combination of the cartridge 46, the stacks 18 of utensils 12 contained therewithin and the lid member 56.

In preparing the cutlery dispenser system 10 for dispensing the utensils 12, the layer of elastomeric material 78 may be removed and the cartridge 46 may be inserted into one of the bins 26. The lid member 56 may be removed exposing an uppermost one of the utensils 12 in each one of the stacks 18. If a support rack 62 is included with the cutlery dispenser system 10, the bins 26 may be mounted on the support rack 62 such as by engaging the hook flange 36 to the groove 64 as shown in FIG. 10. If the support rack 62 is provided in a tiered configuration, lower ones of the bins 26 may be filled with condiment packets, napkins and the like. However, both upper and lower ones of the bins 26 may be utilized to contain cartridges 46 filled with utensils 12. The cartridge 46 may be inserted into the bin 26 through the bin front 28. The user desiring to remove one of the utensils 12 may grasp the utensil 12 by the handle 14 which extends laterally outwardly past the cartridge side 52. The user then may lift the utensil 12 upwardly beyond the cartridge top 50 to remove the utensil 12 from the vertical slot 48.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A cutlery dispenser system for dispensing cutlery utensils, each one of the cutlery utensils having an elongate handle, the dispenser system comprising:
a bin having an open bin front; and
a cartridge being removably insertable into the bin through the bin front and having at least one vertical slot opening to a cartridge top and a cartridge side, the vertical slot being configured to contain a stack of the utensils such that the handles thereof protrude laterally beyond the cartridge side and wherein the vertical slot is configured such that at least one of the utensils may be removed by upward movement thereof beyond the cartridge top.

2. The cutlery dispenser system of claim 1 further comprising a bin cover and wherein the bin has an open bin top, the bin cover being disposed upon the bin top to partially enclose the bin.

3. The cutlery dispenser system of claim 1 wherein the vertical slot is shaped complementary to an outline of one of the cutlery utensils.

4. The cutlery dispenser system of claim 1 wherein the vertical slot is sized to accommodate knives or forks or spoons.

5. The cutlery dispenser system of claim 1 further including a lid member removably engagable to the cartridge top.

6. The cutlery dispenser system of claim 1 wherein the bin has a bottom panel, a rear wall and opposing side walls interconnected by the bottom panel and the rear wall.

7. The cutlery dispenser system of claim 6 wherein the bottom panel has a vertical lip extending upwardly therefrom to restrict movement of the cartridge.

8. The cutlery dispenser system of claim 1 wherein the bin includes a plurality of bays with adjacent ones of the bays being separated by a divider panel, each one of the bays being configured to receive one of the cartridges.

9. The cutlery dispenser system of claim 1 further including a support rack configured to removably mount the bin thereto.

10. The cutlery dispenser system of claim 9 wherein the support rack has an elongate groove formed in an upper portion thereof, the bin has a hook flange formed on a side opposite that of the bin front, the hook flange being configured to be removably engagable to the groove for securing the bin to the support rack.

11. The cutlery dispenser system of claim 9 wherein the support rack is sized and configured to support a plurality of bins in side-by-side arrangement.

12. The cutlery dispenser system of claim 9 wherein the support rack includes a pair of spaced-apart opposing side members interconnected by a first transverse member, the elongate groove being formed in an upper portion of the first transverse member.

13. The cutlery dispenser system of claim 12 wherein the support rack further includes a second transverse member disposed in generally parallel spaced arrangement to the first transverse member in a tiered configuration, the second transverse member being configured to support at least one of the bins.

14. The cutlery dispenser system of claim 1 wherein the cartridge, the bin and the support rack are each fabricated of polymeric material.

15. The cutlery dispenser system of claim 1 wherein the support rack is mounted to a rotatable base.

16. A cutlery dispenser system for dispensing cutlery utensils, each one of the cutlery utensils having an elongate handle, the dispenser system comprising:
a support rack;
a bin being removably mountable to the support rack and having an open bin front; and
a cartridge being removably insertable into the bin through the bin front and having at least three vertical slots disposed in side-be-side arrangement, each one of the vertical slots opening to a cartridge top and a cartridge side and being configured to contain a stack of the utensils such that the handles thereof protrude laterally beyond the cartridge side and wherein the vertical slots are configured such that at least one of the utensils in a respective one of the stacks may be removed by upward movement thereof beyond the cartridge top.

17. The cutlery dispenser system of claim 16 further comprising a bin cover and wherein the bin has an open bin top, the bin cover being disposed upon the bin top to partially enclose the bin.

18. The cutlery dispenser system of claim 16 wherein the vertical slots are shaped complementary to an outline of one of the cutlery utensils.

19. The cutlery dispenser system of claim 16 wherein the vertical slots are substantially identically shaped.

20. The cutlery dispenser system of claim 16 further including a lid member removably engagable to the cartridge top.

21. The cutlery dispenser system of claim 16 wherein the support rack has an elongate groove formed in an upper portion thereof, the bin has a hook flange formed on a side opposite that of the bin front, the hook flange being configured to be removably engagable to the groove for securing the bin to the support rack.
